(19) United States
(12) Patent Application Publication
(10) Pub. No.: US 2014/0280387 A1
(43) Pub. Date: Sep. 18, 2014

(54) SYSTEM AND METHOD FOR EXPANDING STORAGE SPACE OF NETWORK DEVICE

(71) Applicant: HON HAI PRECISION INDUSTRY CO., LTD., New Taipei (TW)

(72) Inventors: JUI-LUNG LIN, New Taipei (TW); PEI-LING CHEN, New Taipei (TW); ZHEN-HONG WU, New Taipei (TW); KUO-YUAN CHANG, New Taipei (TW)

(73) Assignee: HON HAI PRECISION INDUSTRY CO., LTD., New Taipei (TW)

(21) Appl. No.: 14/200,245

(22) Filed: Mar. 7, 2014

(30) Foreign Application Priority Data
Mar. 12, 2013 (TW) 102108564

(51) Int. Cl. G06F 17/30

(52) U.S. Cl. CPC G06F 17/30312
USPC 707/812

(57) ABSTRACT

A method for expanding storage space using a network device is provided. The method sets a storage order of cloud storage space for expanding a local storage space in the network device. When target data is received from the network device, the method stores the target data into the local storage space when a size of an available storage space of the local storage space is more than or equal to a preset value. When the available storage space is less than the preset value, the method copies the earliest stored data of the local storage space into one or more specified cloud storage spaces according to the storage order, and deletes the copied data from the local storage space. The next earliest stored data is copied if the available storage space is still less than the preset value.

### FIELD

Embodiments of the present disclosure relate to storage space management technology, and particularly to a system and method for expanding storage space of a network device.

### BACKGROUND

Network devices, such as IP cameras and network video recorders (NVRs) can include storage devices for storing media data. The storage devices can be secure digital (SD) cards or network attached storage (NAS) devices, for example. However, a storage space of the storage device can be limited. If the storage space is not enough, additional storage devices need to be added, or the storage device needs to be replaced with another storage device having a larger storage space. It is inconvenient and inefficient to manage the storage spaces of multiple storage devices.

### BRIEF DESCRIPTION OF THE DRAWINGS

Implementations of the present disclosure will now be described, by way of example only, with reference to the following drawings. The modules in the drawings are not necessarily drawn to scale, the emphasis instead being placed upon clearly illustrating the principles of the present disclosure. Moreover, in the drawings, like reference numerals designate corresponding portions throughout the views.

FIG. 1 is a block diagram of one embodiment of a network device including a storage space expanding system.

FIG. 2 is a block diagram of one embodiment of function modules of a storage space expanding system of a network device.

FIG. 3 is a flowchart of one embodiment of a method for expanding storage space using a network device.

FIG. 4 is schematic diagram of one embodiment of expanding a storage space of a network device.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references can mean “at least one,” or “one or more.”

In the present disclosure, “module,” refers to logic embodied in hardware or firmware, or to a collection of software instructions, written in a program language. In one embodiment, the program language can be Java, C, or assembly. One or more software instructions in the modules can be embedded in firmware, such as in an EPROM. The modules described herein can be implemented as either software and/or hardware modules and can be stored in any type of non-transitory computer-readable media or storage medium. Non-limiting examples of a non-transitory computer-readable medium include CDs, DVDs, flash memory, and hard disk drives.

FIG. 1 is a block diagram of one embodiment of a network device 10 including a storage space expanding system 100. In one embodiment, the network device 10 may be a network camera, a network video recorder (NVR), or any other network device. The network device 10 can be connected to a cloud network 30 through a network address translating (NAT) device 20 (for example, a network router). The cloud network 30 provides a plurality of cloud storage spaces for the network device 10. As shown in FIG. 1, the cloud network 30 provides a plurality of cloud storage spaces 1 to N for the network device 10.

The network device 10 further includes a local storage space 40. The local storage space 40 may be provided by a storage device 50 inside of or connected to the network device 10. The storage device 50 may be a dedicated memory, such as an erasable programmable read-only memory (EPROM), a hard disk drive (HDD), or flash memory. The local storage space 40 also may be provided by a network attached storage (NAS) device 60 being within the same local area network (LAN) as the network device 10.

FIG. 2 is a block diagram illustrating function modules of the storage space expanding system 100. In this embodiment, the storage space expanding system 100 includes a setting module 110, a receiving module 120, a detection module 130, a storing module 140, and an expanding module 150. The modules 110-150 include computerized code in the form of one or more programs that are stored in the non-transitory storage device 50 of the network device 10. The computerized code includes instructions that are executed by at least one processor 80 of the network device 10 to provide functions of the storage space expanding system 100.

Using the above-mentioned modules, when the network device 10 is required to store data (for example, target data 70), the storage space expanding system 100 detects an available storage space of the local storage space 40. If the available storage space is not enough for storing the target data 70, the storage space expanding system 100 transfers the earliest stored data in the local storage space 40 to one or more cloud storage spaces of the cloud network 30, thus freeing enough space of the local storage space 40 to store the target data 70. A description of each module of the storage space expanding system 100 is given in the following paragraphs.

FIG. 3 is a flowchart of one embodiment of a method for expanding storage space using the network device 10. Depending on the embodiment, additional steps may be added, others removed, and the ordering of the steps may be changed.

In step S10, the setting module 110 sets a storage order of the cloud storage spaces of the cloud network 30 for expanding the local storage space 40 of the network device 10. The storage order determines a sequence for storing specified data of the network device 10 into one or more cloud storage spaces. In one embodiment, the setting module 110 stores access information of one or more available cloud storage spaces of the cloud network 30 in a configuration file of the network device 10. The access information includes, but is not limited to, an access path, an access account, and an access password of each of the available cloud storage spaces.

In one embodiment, the storage order is set according to an order of the access information in the configuration file. The specified data of the network device 10 is stored into one or more specified cloud storage spaces according to the order of the access information. If a current specified cloud storage space is not enough for storing the specified data, the specified data can be stored in another specified cloud storage space, for example the next specified cloud storage space.

FIG. 4 shows an example of the storage order, which can also be set according to a current time of storing a specified data. Each cloud storage space corresponds to a preset time period, and the specified data is stored in the corresponding cloud storage space according to the current time. In another embodiment, the specified data is divided into a plurality of parts corresponding to a number of the cloud storage spaces, and each part of the specified data is stored into the corresponding cloud storage space.

In step S20, the receiving module 120 receives target data 70 from the network device 10. In one embodiment, the target data 70 is media data recorded by the network device 10 (e.g., a network camera).

In step S30, the detection module 130 detects an available storage space of the local storage space 40.

In step S40, the detection module 130 determines whether a size of the available storage space is less than a preset value. In one embodiment, the preset value is set dynamically according to a size of the target data 70, and a size of the preset value is greater than or equal to the size of the target data 70. For example, if the size of the target data 70 is 200 megabytes (MB), the preset value is set to be equal to or greater than 200 MB. In other embodiments, the preset value may be set to be a fixed value according to actual requirements. If the size of the available storage space is less than the preset value, step S60 is implemented. If the size of the available storage space is greater than or equal to the preset value, step S50 is implemented.

In step S50, the storing module 140 stores the target data 70 into the local storage space 40, and the procedure ends.

In step S60, the expanding module 150 copies the earliest stored data of the local storage space 40 into one or more specified cloud storage spaces according to the storage order. In the illustrated embodiment, the earliest stored data in the local storage space 40 is file “a1,” and the expanding module 150 copies the file “a1” into the corresponding specified cloud storage space/s according to the storage order.

In step S70, the expanding module 150 deletes the copied data (e.g. file “a1”) from the local storage space 40, thus freeing storage space from the local storage space 40, and the procedure returns to step S30. Step S60 is repeated, until the size of the available storage space is greater than or equal to the preset value, and the storing module 140 stores the target data 70 into the local storage space 40.

All of the processes described above may be embodied in, and fully automated via, functional code modules executed by one or more general purpose processors such as the processor 80. The code modules may be stored in any type of non-transitory readable medium or other storage device such as the storage device 50. Some or all of the methods may alternatively be embodied in specialized hardware. Depending on the embodiment, the non-transitory readable medium may be a hard disk drive, a compact disc, a digital versatile disc, a tape drive, or other suitable storage medium.

The described embodiments are merely examples of implementations, and have been set forth for a clear understanding of the principles of the present disclosure. Variations and modifications may be made without departing substantially from the spirit and principles of the present disclosure. All such modifications and variations are intended to be included within the scope of this disclosure and the described inventive embodiments, and the present disclosure is protected by the following claims and their equivalents.

What is claimed is:

1. A method for expanding storage space using a network device, the network device being connected to a cloud network which provides a plurality of cloud storage spaces, the method comprising:
setting a storage order of the plurality of cloud storage spaces for expanding a local storage space in the network device;
receiving target data from the network device;
determining whether a size of an available storage space of the local storage space is less than a preset value; and
storing the target data into the local storage space when the size of the available storage space is more than or equal to the preset value; or
copying the earliest stored data in the local storage space to one or more specified cloud storage spaces according to the storage order and deleting the copied data in the local storage space when the size of the available storage space is less than the preset value, until the size of the available storage space is great than or equal to the preset value.

2. The method according to claim 1, further comprising:
storing access information of one or more available cloud storage spaces in the cloud network as a configuration file of the network device, the access information comprising an access path, an access account, and an access password of each of the one or more available cloud storage spaces.

3. The method according to claim 2, wherein the storage order is set according to an order of the access information of the one or more available cloud storage spaces in the configuration file, the copied data is stored into the one or more specified cloud storage spaces according to the order of the access information, and the copied data is stored into a next specified cloud storage space if a current specified cloud storage space is not enough for storing the copied data.

4. The method according to claim 1, wherein the storage order is set according to a storing method of dividing the copied data into a plurality of parts according to a number of the plurality of cloud storage spaces, and storing each part of the copied data into each of the plurality of cloud storage spaces.

5. The method according to claim 1, wherein the storage order is set according to a storing method of storing the copied data into a specified cloud storage space corresponding to a preset time period which current time belongs to.

6. The method according to claim 1, wherein the preset value is set dynamically according to a size of the target data, and a size of the preset value is great than or equal to the size of the target data.

7. A network device, the network device being connected to a cloud network which providing a plurality of cloud storage space, the network comprising:
at least one processor; and
a storage device storing one or more programs, when executed by the at least one processor, cause the at least one processor to perform operations of:
setting a storage order of the plurality of cloud storage spaces for expanding a local storage space in the network device;
receiving target data from the network device;
determining whether a size of an available storage space of the local storage space is less than a preset value; and
storing the target data into the local storage space when the size of the available storage space is more than or equal to the preset value; or
copying the earliest stored data in the local storage space to one or more specified cloud storage spaces according to the storage order and deleting the copied data in the local storage space when the size of the available storage space is less than the preset value, until the size of the available storage space is great than or equal to the preset value.

8. The network device according to claim 7, further comprising:
storing access information of one or more available cloud storage spaces in the cloud network as a configuration file of the network device, the access information comprising an access path, an access account, and an access password of each of the one or more available cloud storage spaces.

9. The network device according to claim 8, wherein the storage order is set according to an order of the access information of the one or more available cloud storage spaces in the configuration file, the copied data is stored into the one or more specified cloud storage spaces according to the order of the access information, and the copied data is stored into a next specified cloud storage space if a current specified cloud storage space is not enough for storing the copied data.

10. The network device according to claim 7, wherein the storage order is set according to a storing method of dividing the copied data into a plurality of parts according to a number of the plurality of cloud storage spaces, and storing each part of the copied data into each of the plurality of cloud storage spaces.

11. The network device according to claim 7, wherein the storage order is set according to a storing method of storing the copied data into a specified cloud storage space corresponding to a preset time period which current time belongs to.

12. The network device according to claim 7, wherein the preset value is set dynamically according to a size of the target data, and a size of the preset value is great than or equal to the size of the target data.

13. A non-transitory storage medium having stored thereon instructions that, when executed by at least one processor of a network device, cause the processor to perform a method for expanding storage space using the network device, the network device being connected to a cloud network which provides a plurality of cloud storage space, the method comprising:
setting a storage order of the plurality of cloud storage spaces for expanding a local storage space in the network device;
receiving target data from the network device;
determining whether a size of an available storage space of the local storage space is less than a preset value; and
storing the target data into the local storage space when the size of the available storage space is more than or equal to the preset value; or
copying the earliest stored data in the local storage space to one or more specified cloud storage spaces according to the storage order and deleting the copied data in the local storage space when the size of the available storage space is less than the preset value, until the size of the available storage space is great than or equal to the preset value.

14. The storage medium according to claim 13, further comprising:
storing access information of one or more available cloud storage spaces in the cloud network as a configuration file of the network device, the access information comprising an access path, an access account, and an access password of each of the one or more available cloud storage spaces.

15. The storage medium according to claim 14, wherein the storage order is set according to an order of the access information of the one or more available cloud storage spaces in the configuration file, the copied data is stored into the one or more specified cloud storage spaces according to the order of the access information, and the copied data is stored into a next specified cloud storage space if a current specified cloud storage space is not enough for storing the copied data.

16. The storage medium according to claim 13, wherein the storage order is set according to a storing method of dividing the copied data into a plurality of parts according to a number of the plurality of cloud storage spaces, and storing each part of the copied data into each of the plurality of cloud storage spaces.

17. The storage medium according to claim 13, wherein the storage order is set according to a storing method of storing the copied data into a specified cloud storage space corresponding to a preset time period which current time belongs to.

18. The storage medium according to claim 13, wherein the preset value is set dynamically according to a size of the target data, and a size of the preset value is great than or equal to the size of the target data.
